(19) United States
(12) Patent Application Publication
(10) Pub. No.: US 2016/0158108 A1
(43) Pub. Date: Jun. 9, 2016

(54) AUTOMATED MEDICATION DISPENSING AND RELATED APPLICATIONS THEREOF

(71) Applicant: VAICA MEDICAL LTD, Tel-Aviv (IL)

(72) Inventors: Tomer GOFER, Yavne (IL); Gil MARGALIT, Herzlia (IL)

(21) Appl. No.: 14/896,710

(22) PCT Filed: Jun. 9, 2014
(86) PCT No.: PCT/IL2014/050517

§ 371 Date: Dec. 8, 2015

Related U.S. Application Data
(60) Provisional application No. 61/832,883, filed on Jun. 9, 2013.

(51) Int. Cl. A61J 7/00; A61J 1/03; G06K 7/10; A61J 7/02

(52) U.S. Cl. CPC A61J 7/0084; A61J 7/02; A61J 1/035; G06K 7/10366; A61J 2205/60; A61J 2205/10; A61J 2200/70; A61J 7/0069

(57) ABSTRACT

Automated medication dispensing devices, kits, systems, methods, and related applications thereof, such as using computer readable (e.g., NFC [near field communication], or QR) standards for monitoring and verifying patient and caregiver activities and health related data-information. The medication dispensing device includes: a housing having a sliding mechanism configured to receive, hold, and release a removably slidable medication holder containing a plurality of individual medication holding compartments. The medication holder for dispensing medication includes: a receptacle (as either a disposable blister pack, or a reusable medication tray) containing a plurality of individual medication holding compartments, and having one side configured with one or more outward facing holes or an outward facing external handle to facilitate removably sliding the medication holder into and out of a medication dispensing device.

### RELATED APPLICATION

This application claims the benefit of priority under 35 USC 119(e) of U.S. Provisional Patent Application No. 61/832,883, filed Jun. 9, 2013, entitled “MEDICATION DISPENSER BLISTER PACK, A TRAY, DEVICES THEREOF, SYSTEMS THEREOF AND METHODS AND APPLICATIONS THEREOF”, the contents of which are incorporated herein by reference in their entirety.

### FIELD OF THE INVENTION

The present invention, in some embodiments thereof, relates to the field of automated (automatic) medication dispensing and applications thereof, and more particularly, but not exclusively, to automated medication dispensing devices, kits, systems, methods, and related applications thereof, such as using computer readable (e.g., NFC [near field communication], or QR [quick response]) standards for monitoring and verifying patient and caregiver activities and health related data-information.

### BACKGROUND OF THE INVENTION

Teachings of or/and relating to automated (automatic) medication dispensing are well known and taught about in scientific, technical, and patent, literature, and currently widely practiced in the general field of health and patient care.

PCT International Patent Application Publication No. WO 2008/004212, and U.S. Pat. No. 8,085,135, both by same applicant/assignee of the present disclosure, are directed to teachings about medication dispensing equipment and methodologies. The latter disclosure incorporates use of RFID technology, for example, as part of scheduling, determining, and monitoring medication consumption.

In spite of extensive teachings in the field of automated (automatic) medication dispensing, there is an on-going need for developing and practicing improved and new medication dispensing equipment and methodologies, and related applications thereof.

### SUMMARY OF THE INVENTION

The present invention, in some embodiments thereof, relates to the field of automated (automatic) medication dispensing, and more particularly, but not exclusively, to automated medication dispensing devices, kits, systems, methods, and applications thereof, such as using computer readable (e.g., NFC [near field communication], or QR) standards for monitoring and verifying patient and caregiver activities and health related data-information.

According to an aspect of some embodiments of the present invention there is provided a medication dispensing device, comprising: a housing having a sliding mechanism configured to receive, hold, and release a removably slidable medication holder containing a plurality of individual medication holding compartments.

According to some embodiments of the invention, for the medication dispensing device, the sliding mechanism is configured to receive, hold, and release the medication holder according to at least one feature selected from the group consisting of structural features, electronic features, RF features, magnetic features, and visual features.

According to some embodiments of the invention, for the medication dispensing device, the sliding mechanism is configured to receive, hold, and release the medication holder having one or more specific structural features.

According to some embodiments of the invention, the medication dispensing device comprises structural features correspondingly matching the one or more specific structural features of the medication holder.

According to some embodiments of the invention, for the medication dispensing device, the correspondingly matching structural features are spatial clearances, pegs, or a combination thereof.

According to some embodiments of the invention, the medication dispensing device comprises one or more electronic sensors configured to sense insertion or/and removal, via the sliding mechanism, of the medication holder.

According to some embodiments of the invention, the medication dispensing device comprises at least one electronic reader selected from the group consisting of NFC readers, RFID readers, QR code readers, and barcode readers.

According to some embodiments of the invention, for the medication dispensing device, the electronic reader is configured to communicate with the medication holder.

According to some embodiments of the invention, the medication dispensing device comprises at least one electronic writer configured to record on an NFC/RFID tag in response to receiving data from the medication holder.

According to some embodiments of the invention, for the medication dispensing device, the at least one electronic writer is selected from the group consisting of NFC writers and RFID writers.

According to an aspect of some embodiments of the present invention there is provided a medication holder for dispensing medication, comprising: a receptacle containing a plurality of individual medication holding compartments, and having one side configured with one or more outward facing holes or an outward facing external handle to facilitate removably sliding the medication holder into and out of a medication dispensing device.

According to some embodiments of the invention, the medication holder receptacle is a disposable blister pack.

According to some embodiments of the invention, the medication holder receptacle is a reusable tray.

According to some embodiments of the invention, the medication holder receptacle is configured with an RFID or NFC tag.

According to some embodiments of the invention, for the medication holder, the RFID or NFC tag is configured to communicate with the medication dispensing device.

According to some embodiments of the invention, for the medication holder, the RFID or NFC tag is configured to send programming data-information to the medication dispensing device, wherein the data-information is used to program the medication dispensing device.

According to an aspect of some embodiments of the present invention there is provided a medication cup, comprising: a cup with a first end having tearing elements configured to tear a sealed covering of a medication compartment contained in a medication holder, and a second end configured open to retrieve medication from the medication compartment.

According to some embodiments of the invention, the medication cup further comprising a removable cover of the second end.

According to an aspect of some embodiments of the present invention there is provided a medication dispensing kit, comprising: the medication dispensing device; and the medication holder.

According to some embodiments of the invention, the medication dispensing kit further comprises the medication cup.

According to an aspect of some embodiments of the present invention there is provided a method for dispensing medication, the method comprising: providing a medication dispensing device; providing a medication holder having at least one medication holding compartment filled with medication; inserting, by sliding, the medication holder into the medication dispensing device; sensing an indication of the inserted medication holder; verifying the inserted medication holder as being correct; and retrieving medication from at least one of the filled medication holding compartments.

According to an aspect of some embodiments of the present invention there is provided a medication dispensing system, comprising: a medication dispensing device comprising a housing having a sliding mechanism; and a medication holder comprising a receptacle containing a plurality of individual medication holding compartments, and configured to removably slide into and out of the medication dispensing device via the sliding mechanism.

According to an aspect of some embodiments of the present invention there is provided a method for using computer readable standards for monitoring visit of a caregiver to a patient, the method comprising: providing to the patient a medication dispensing device configured with RFID circuitry operative according to the computer readable standards; providing to the caregiver an RFID tag operative according to the computer readable standards and containing caregiver ID data-information; communicating the caregiver ID data-information to the medication dispensing device RFID circuitry via the computer readable standards; and analyzing the caregiver ID data-information by the RFID circuitry.

According to some embodiments of the invention, the communicating includes communicating arrival and departure time data-information of the caregiver to the patient.

According to some embodiments of the invention, the analyzing includes verifying correctness of the caregiver ID data-information.

According to an aspect of some embodiments of the present invention there is provided a method for using computer readable standards for verifying health data-information of a patient, the method comprising: providing to the patient a medication dispensing device configured with RFID circuitry operative according to the computer readable standards and containing patient health data-information; providing to the patient an RFID tag operative according to the computer readable standards and containing patient ID data-information; communicating the patient ID data-information to the medication dispensing device RFID circuitry via the computer readable standards; and verifying association of the patient health data-information with the patient ID data-information by the RFID circuitry.

According to an aspect of some embodiments of the present invention there is provided a method for using computer readable standards for dispensing medication, the method comprising: providing a medication dispensing device configured with RFID circuitry operative according to the computer readable standards; providing a medication holder configured with an RFID tag operative according to the computer readable standards and containing medication holder ID data-information, the medication holder has at least one medication holding compartment filled with medication; inserting the medication holder into the medication dispensing device; communicating the medication holder ID data-information to the medication dispensing device RFID circuitry via the computer readable standards; and verifying the inserted medication holder as being correct by the RFID circuitry.

According to some embodiments of the invention, the computer readable standards are NFC (near field communication) standards.

According to some embodiments of the invention, the computer readable standards are QR code standards.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of some embodiments of the invention can involve performing or completing selected tasks (steps, procedures) manually, automatically, or a combination thereof. Moreover, according to actual instrumentation and equipment of some embodiments of the invention, several selected tasks could be implemented by hardware, software, firmware, or a combination thereof, using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks as described herein may be performed by a data processor, such as a computing platform for executing a plurality of instructions. Optionally, the data processor includes a volatile memory for storing instructions or/and data or/and a non-volatile storage, for example, a magnetic hard-disk or/and removable media, for storing instructions or/and data. Optionally, a network connection is provided as well. A display or/and a user input device such as a keyboard or mouse are optionally provided as well.

### BRIEF DESCRIPTION OF THE DRAWINGS

Some embodiments of the present invention are herein described, by way of example only, with reference to the accompanying drawings. With specific reference now to the drawings in detail, it is stressed that the particulars shown are by way of example and for purposes of illustrative description of some embodiments of the present invention. In this regard, the description taken together with the accompanying drawings make apparent to those skilled in the art how some embodiments of the present invention may be practiced.

In the drawings:

FIG. 1 is a schematic front and side view of a medication dispensing device, shown containing a fully inserted medication holder, in accordance with some embodiments of the invention;

FIG. 2 is a schematic perspective view of an exemplary medication holder (a disposable medication blister pack), for use with the medication dispensing device, in accordance with some embodiments of the invention;

FIG. 3 is a schematic perspective view of an exemplary medication holder (a reusable medication tray), for use with the medication dispensing device, in accordance with some embodiments of the invention;

FIG. 4 is a schematic perspective view of an exemplary medication holder (disposable medication blister pack) shown with the individual medication compartments covered and sealed with a covering/sealing material, in accordance with some embodiments of the invention;

FIG. 5 is a schematic front and side view of the medication dispensing device shown containing a partially inserted medication holder (disposable medication blister pack or reusable medication tray) having outward facing holes, in accordance with some embodiments of the invention;

FIG. 6 is a schematic front and side view of the medication dispensing device shown containing a partially inserted medication holder (disposable medication blister pack or reusable medication tray) having an outward facing external handle, in accordance with some embodiments of the invention;

FIG. 7A is a schematic side view of the medication dispensing device, shown without a medication holder, highlighting an exemplary sliding mechanism, in accordance with some embodiments of the invention;

FIG. 7B is a schematic front view of the medication dispensing device (cover removed), shown without a medication holder, further highlighting an exemplary sliding mechanism, in accordance with some embodiments of the invention;

FIG. 8 is a schematic back and side view of the medication dispensing device, shown with a fully inserted medication holder (disposable medication blister pack or reusable medication tray) whose back side is in a closed position, in accordance with some embodiments of the invention;

FIG. 9 is a schematic back and side view of the medication dispensing device, shown with a fully inserted medication holder (disposable medication blister pack or reusable medication tray) whose back side is in an open position and includes a medication instruction sheet, in accordance with some embodiments of the invention;

FIG. 10 is a schematic front and side view of the medication dispensing device, shown containing a fully inserted medication holder (disposable medication blister pack or reusable medication tray), highlighting an exemplary individual medication compartment (unsealed) whose lid is in an open position, in accordance with some embodiments of the invention;

FIG. 11 is a schematic front and side view of the medication dispensing device, shown containing a fully inserted medication holder (disposable medication blister pack or reusable medication tray), highlighting an exemplary individual medication compartment (sealed) whose lid is in an open position, in accordance with some embodiments of the invention;

FIG. 12 is a schematic perspective view of a medication cup, in accordance with some embodiments of the invention;

FIGS. 13A-13B are schematic views illustrating use of the medication cup to break the cover/seal of an individual medication compartment of a fully inserted medication holder (FIG. 13A: teeth towards medication dispensing device), and to retrieve and hold medication removed therefrom (FIG. 13B: teeth away from medication dispensing device), in accordance with some embodiments of the invention;

FIG. 14 is a schematic front view of the medication dispensing device, shown with an NFC/RFID Tag and an NFC/RFID Reader/Writer, in accordance with some embodiments of the invention;

FIGS. 15A-15B are schematic front and side views of the medication dispensing device, shown with a cover (open, closed positions) configured and interfacing with a locking mechanism (locking elements) [unlocked, locked configurations], in accordance with some embodiments of the invention;

FIG. 16 is a flow diagram of a method for dispensing medication, in accordance with some embodiments of the invention;

FIG. 17 is a flow diagram of a system for dispensing medication, in accordance with some embodiments of the invention;

FIG. 18 is a flow diagram of a method for using computer readable (e.g., NFC [near field communication]) standards for monitoring and verifying patient and caregiver activities and health related data-information, in accordance with some embodiments of the invention; and

FIG. 19 is a flow diagram of a system for using computer readable (e.g., NFC [near field communication]) standards for monitoring and verifying patient and caregiver activities and health related data-information, in accordance with some embodiments of the invention.

### DESCRIPTION OF SPECIFIC EMBODIMENTS OF THE INVENTION

The present invention, in some embodiments thereof, relates to automated medication dispensing devices, kits, systems, methods, and related applications thereof, such as using computer readable (e.g., NFC [near field communication], or QR) standards for monitoring and verifying patient and caregiver activities and health related data-information.

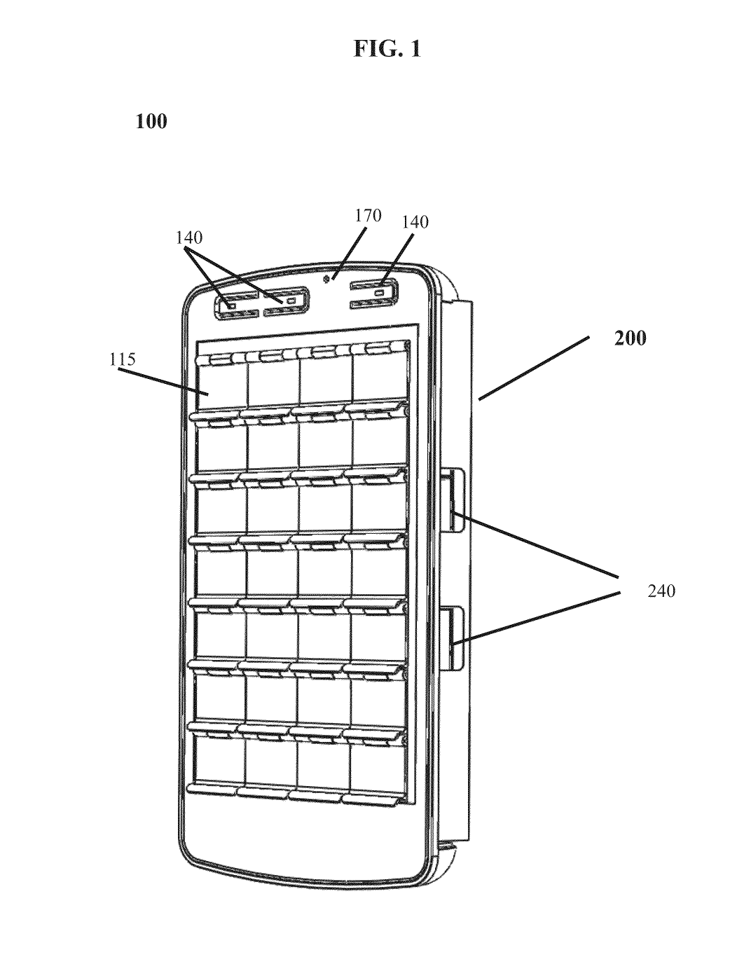

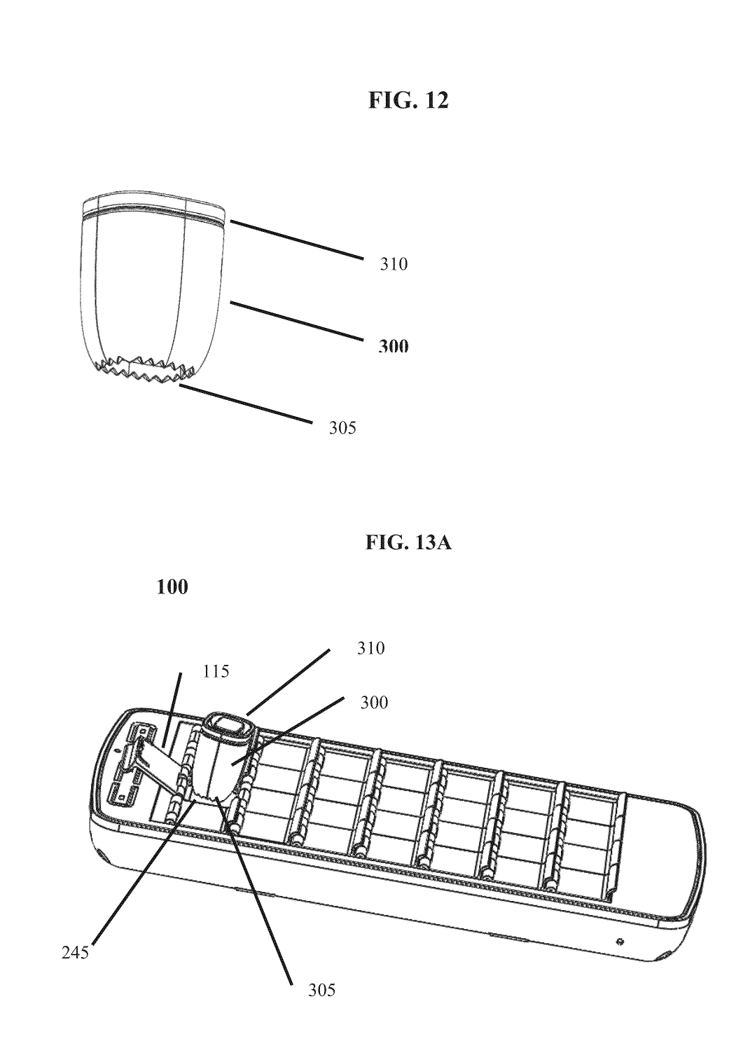

In the following illustrative description of some embodiments of the invention, reference is made to the figures (FIGS. 1 through 19). Throughout the following description and accompanying drawings, same reference numbers refer to same components, elements, or features. It is to be understood that the invention is not necessarily limited in its application to the details of construction and the arrangement of the components and/or methods set forth in the following illustrative description. The invention is capable of other embodiments or of being practiced or carried out in various ways.

Additionally, it is to be fully understood that certain aspects, characteristics, and features, of the present invention, which are illustratively described and presented in the context or format of a plurality of separate embodiments, may also be illustratively described and presented in any suitable combination or sub-combination in the context or format of a single embodiment. Conversely, various aspects, characteristics, and features, of the present invention, which are illustratively described and presented in combination or sub-combination in the context or format of a single embodiment, may also be illustratively described and presented in the context or format of a plurality of separate embodiments.

For example, the following includes illustrative description of several aspects of some embodiments of the invention. Specifically, the following presentation includes illustrative description of some embodiments of a medication dispensing device, a medication holder (for example, in the form of a disposable blister pack or in the form of a reusable tray), a medication cup for use with the medication holder, a kit including a combination of the preceding aspects, a method for dispensing medication, a medication dispensing system, and of various methods and systems for using NFC (near field communication) standards for monitoring, verifying patient or/and caregiver activities and health related data-information. It is to be understood that illustrative description of a given particular aspect of some embodiments of the invention may be considered independent of the respective illustrative description of the other particular aspects of some other embodiments of the invention.

More specifically, for example, it is to be understood that illustrative description of some embodiments of either the method for dispensing medication or the medication dispensing system may be considered independent of the illustrative description of some embodiments of the medication cup, or of the various methods and systems for using NFC (near field communication) standards for monitoring, verifying patient or/and caregiver activities and health related data-information. The same applies vice versa, for example, illustrative description of some embodiments of the various methods and systems for using NFC (near field communication) standards for monitoring, verifying patient or/and caregiver activities and health related data-information may be considered independent of the illustrative description of some embodiments of the medication holder or of the medication cup, etc.

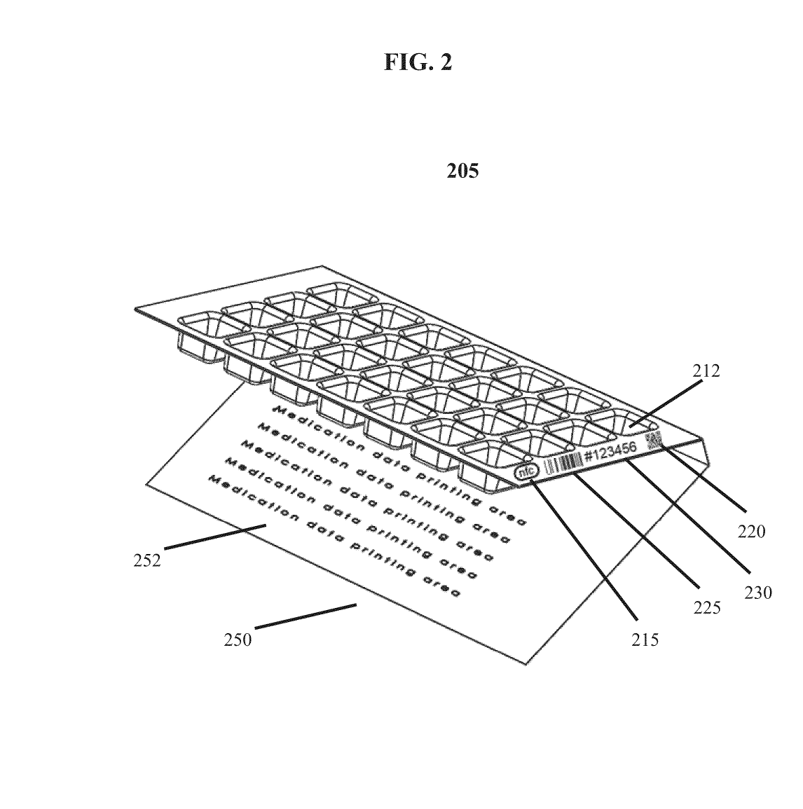

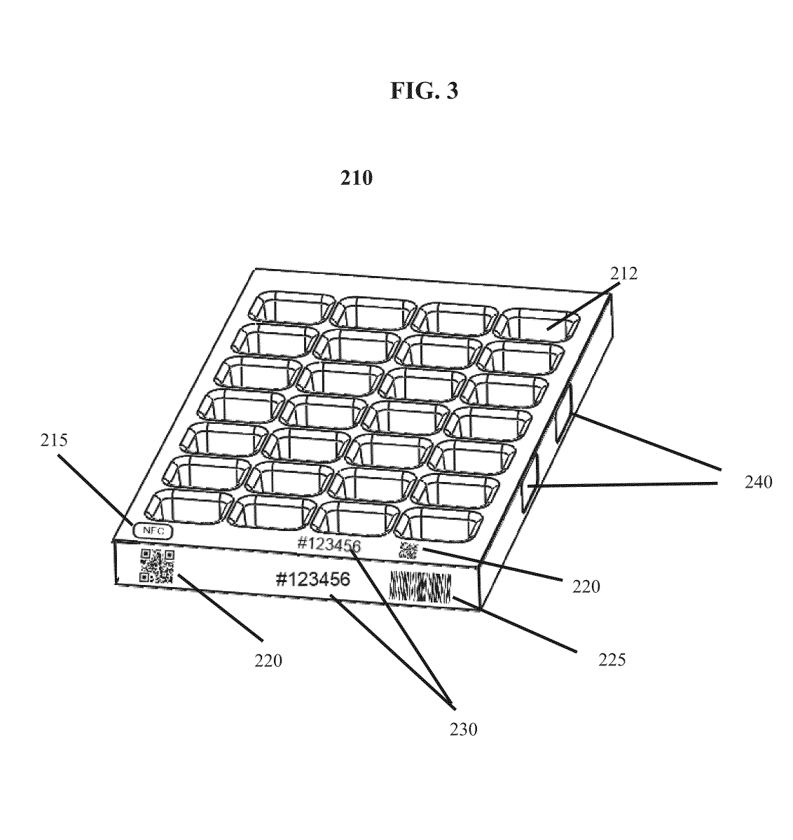

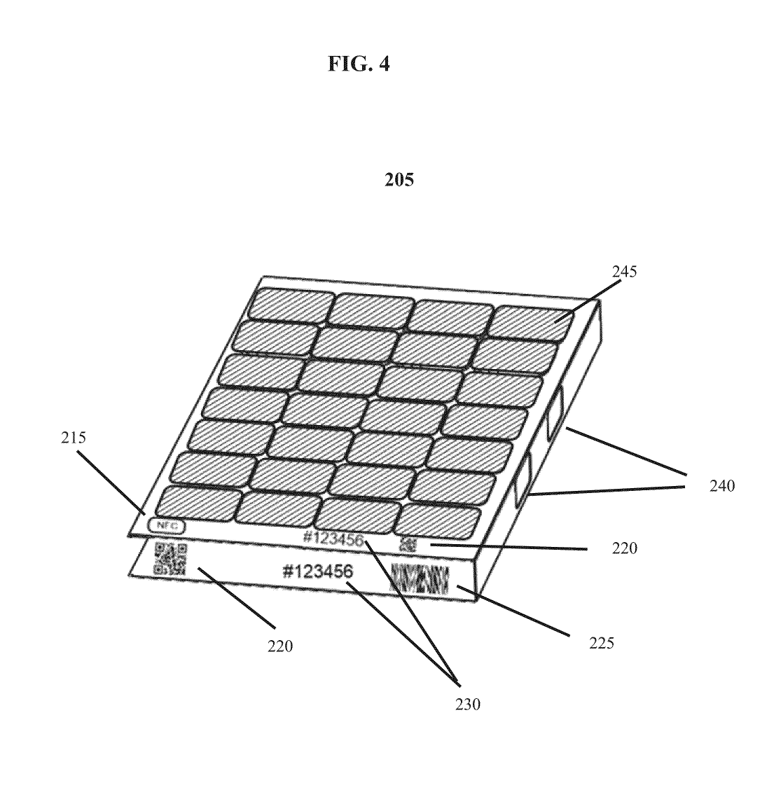

The medication dispenser and reminder (herein, also referred to as medication dispensing device) (for example, 100 in FIGS. 1, 5-11, and 13-15) can hold a medication holder (for example, 200 in FIGS. 1, 5, and 6) in the form of a disposable medication blister pack (unit-dose or multi-dose) (for example, 205 in FIGS. 2 and 4) or in the form of a reusable medication tray (for example, 210 in FIG. 3), having at least one individual medication holding compartment (for example, 212 in FIGS. 2 and 3).

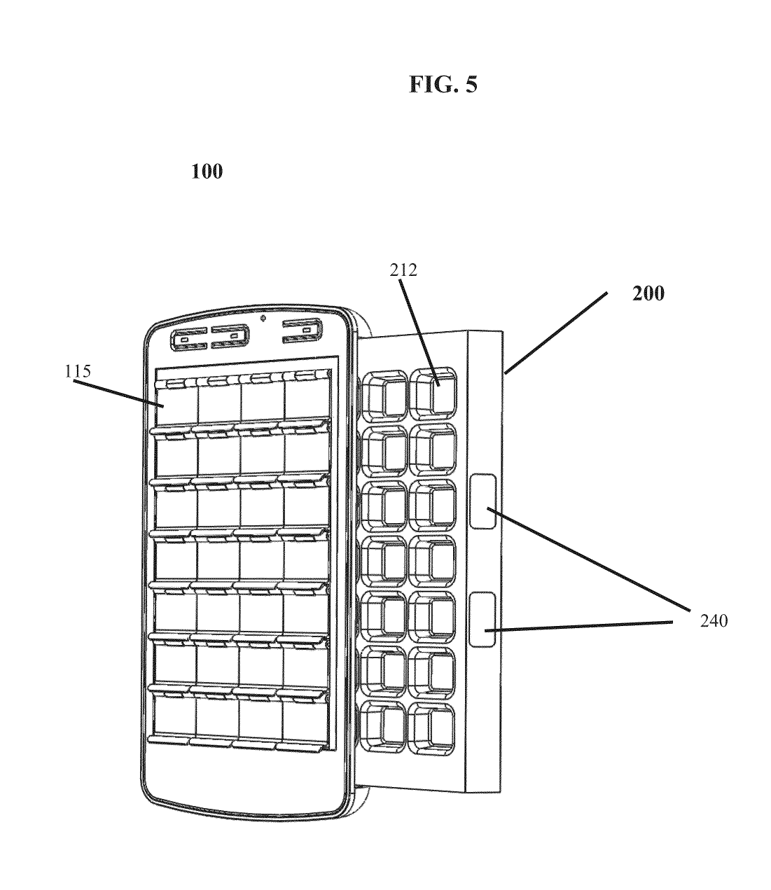

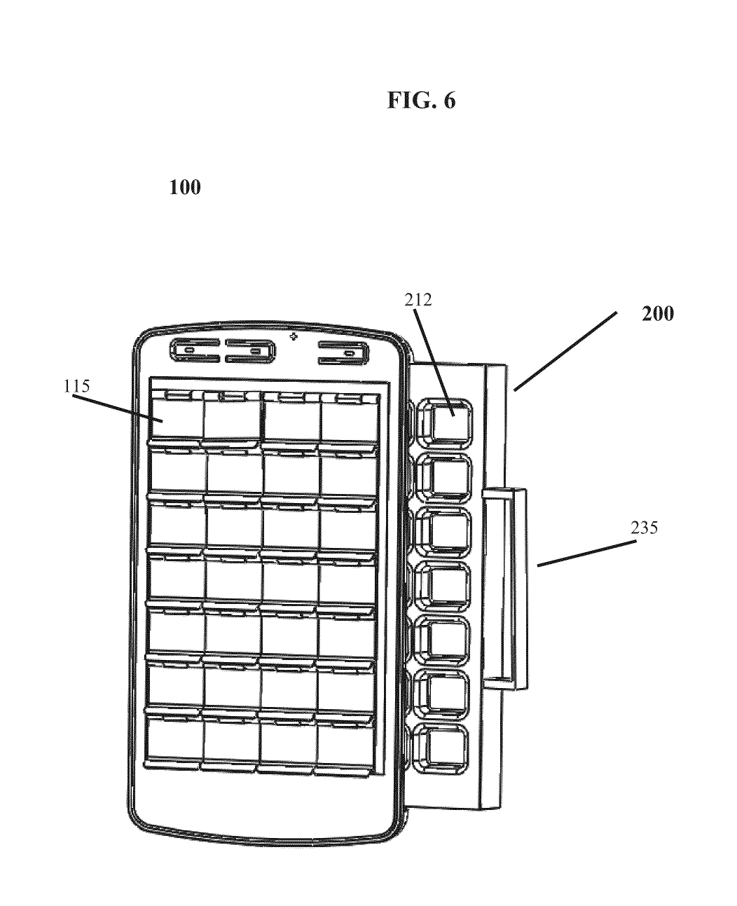

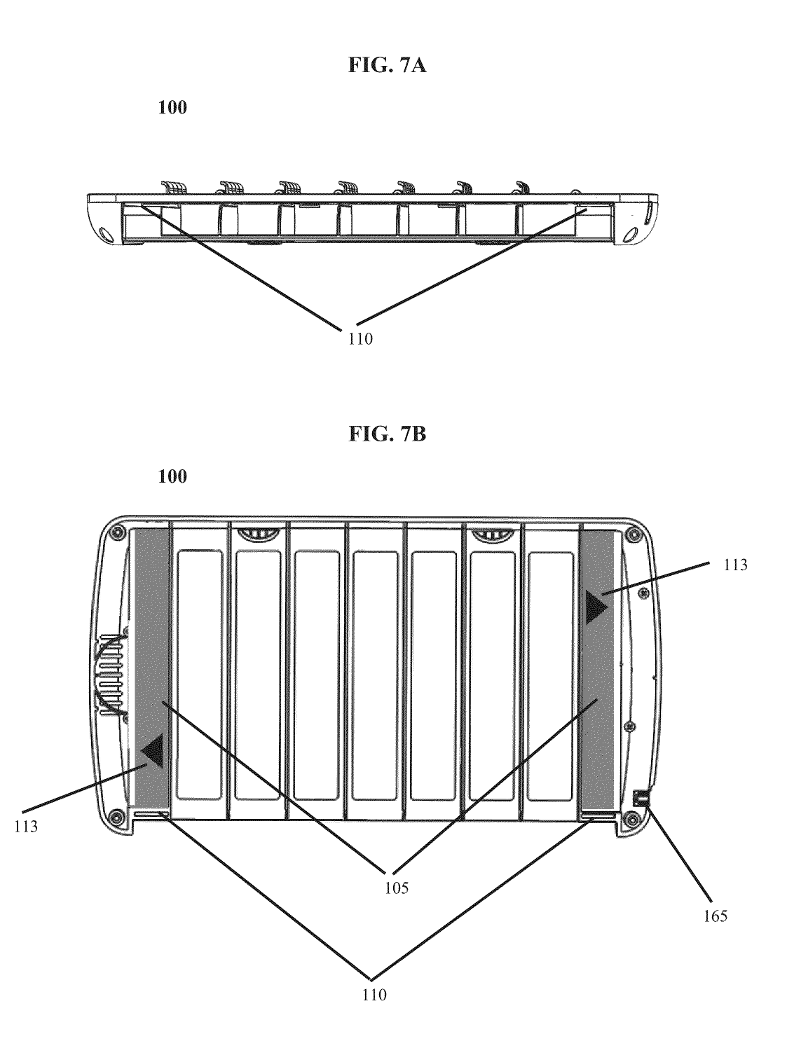

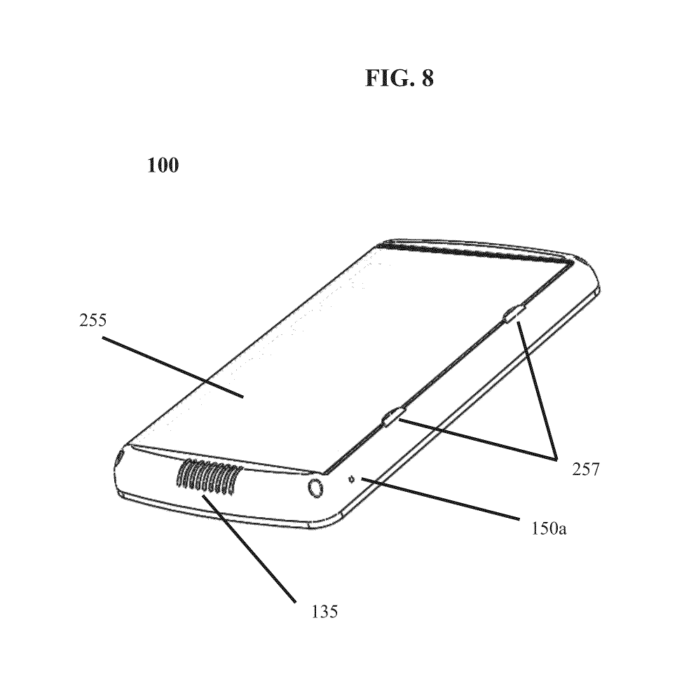

The medication dispensing device 100, optionally, has a sliding mechanism (for example, 105 and 110 in FIGS. 7A-7B) that allows the loading or refilling of the medication dispensing device 100 with a new medication holder 200 (blister pack 205 or tray 210) by sliding the blister pack 205 or the tray 210 into the medication dispensing device 100, sideways, similar to the manner by which VHS cassettes are loaded into a VHS player (for example, as shown in FIGS. 5 and 6).

The side filling mechanism (FIGS. 7A-7B, 105 and 110) of the medication dispensing device 100 described above, optionally, allows the insertion of the medication holder 200 (blister pack 205 or tray 210) in only one direction so there could be no mistake made in inserting the medication holder 200 (blister pack 205 or tray 210) the wrong way. The sliding mechanism, optionally, enables the insertion/removal of the medication holder 200 into the medication dispensing device simply by pushing/pulling the (blister/tray) medication holder 200 sideways, without any need to open the medication dispensing device housing or to attach anything directly to the (blister pack or tray) medication holder 200.

The side sliding filling mechanism (FIGS. 7A-7B, 105 and 110) described above, optionally, has an optional mechanism to accept only blister packs 205 or trays 210 that were specifically designed and constructed (for example, with one or more specific structural features) to work with the medication dispensing device 100, by either mechanical means, such as special obstructions/shapes carved in the blister pack 205/tray 210 and correspondingly matching structural features such as spatial clearances or/and pegs in the medication dispensing device 100 itself, and/or by electronic and/or RF and/or magnetic and/or visual features or means.

The medication dispensing device 100, optionally, has electronic sensor or sensors (for example, 113 in FIG. 7B) to sense the insertion or/and removal, via the sliding mechanism, of a medication holder (blister pack 205 or tray 210), for example, when replacing an empty disposable blister pack 205, or, when resupplying or refilling an empty reusable medication tray 210 with new medication, or, replacing a damaged medication holder (blister pack 205 or tray 210).

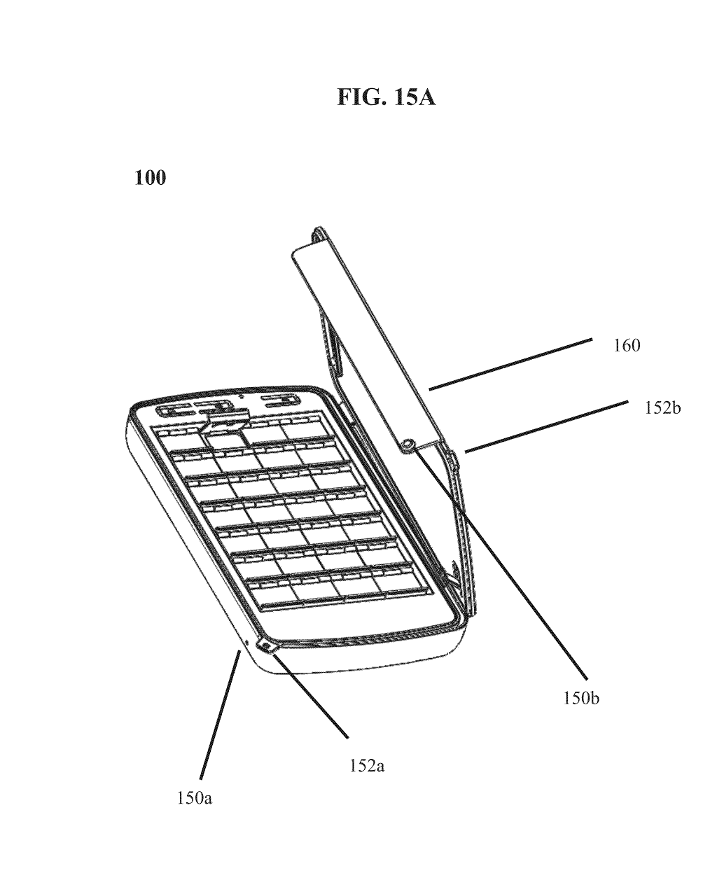

The medication dispensing device 100, optionally, can have a built-in NFC and/or RFID and/or QR (quick response) code and/or barcode and/or magnetic reader/s (for example, 120 in FIG. 14) to read the medication holder 200 (blister pack 205 or tray 210) unique electronic code or serial number and data (for example, 215, 220, 225, 230, in FIGS. 2, 3, 4). The medication holder 200 (blister pack 205 or tray 210), optionally, can deliver data to the medication dispensing device 100 in either visual means, such as embedded in printed QR (quick response) codes or barcodes, or via digitally stored means, such as blister-embedded RFID, NFC or other digitally stored and/or RF and/or magnetic embedded means.

The medication holder 200, optionally, can deliver unique data-information to the medication dispensing device 100 via printed or RF or magnetic embedded means.

The data delivered by the medication holder 200 (blister pack 205 or tray 210) to the medication dispensing device 100, optionally, can be used to directly program the medication dispensing device 100 with specific instructions, such as specific medication schedule for that particular medication holder 200 (blister pack 205 or tray 210), the medication holder 200 (blister pack 205 or tray 210) start and/or expiration date, the patient it is issued to, the identity of the issuing/filling entity, etc. The medication dispensing device 100, optionally, can also use this (blister pack or tray) medication holder 200 encoded data to program back a server with (blister pack or tray) medication holder 200 and patient specific data and to receive from the server instructions that are specific for that unique (blister pack or tray) medication holder 200 or patient.

The medication dispensing device 100, optionally, can have a built-in NFC and/or RFID writer/s (for example, 120 in FIG. 14) to record on an NFC/RFID tag (for example, 125 in FIG. 14) all the information and/or events that the medication dispensing device 100 normally tracks and records, as further described hereinbelow. The NFC/RFID tag 125, optionally, can be (temporarily) embedded in the medication dispensing device 100, or in the medication holder 200 (blister pack 205 or tray 210) or in any other object placed in the physical proximity of the medication dispensing device 100. The data written by the medication dispensing device 100 to the NFC/RFID tag, optionally, can be read and retrieved later by another device, such as a smartphone, a tablet or other computing, communication, or medical device, and be used by that other device for further data processing or to transmit/upload this data to a remote server.

The medication holder 200 (disposable medication blister pack 205 or tray 210), optionally, has an external handle (for example, 235 in FIG. 6) or holes (for example, 240 in FIGS. 1, 3, 4, 5) punched to the outward facing medication holder 200 (blister pack 205 or tray 210) side, to assist and to ease the insertion and removal of the blister pack or tray medication holder 200.

The medication dispensing device 100, optionally, has one or more lids (for example, 115 in FIGS. 1, 5, 6, 10, 11, 13A, 13B), such that there is a lid 115 for the cavity of each individual medication holding compartment 212 of the (blister pack or tray) medication holder 200.

Once a medication holder 200 (blister pack 205 or tray 210) is inserted into the medication dispensing device 100, each individual medication holding compartment cavity 212, optionally, is located directly under a lid 115 of the medication dispensing device 100, such that the lid 115 is aligned with its associated (blister pack or tray) medication holding compartment cavity 212 and the opening of the lid 115 allows direct access to its associated (blister pack or tray) medication holding compartment cavity 212 or to the foil covering it (for example, as shown by 240 in FIGS. 4, 11, and 13A).

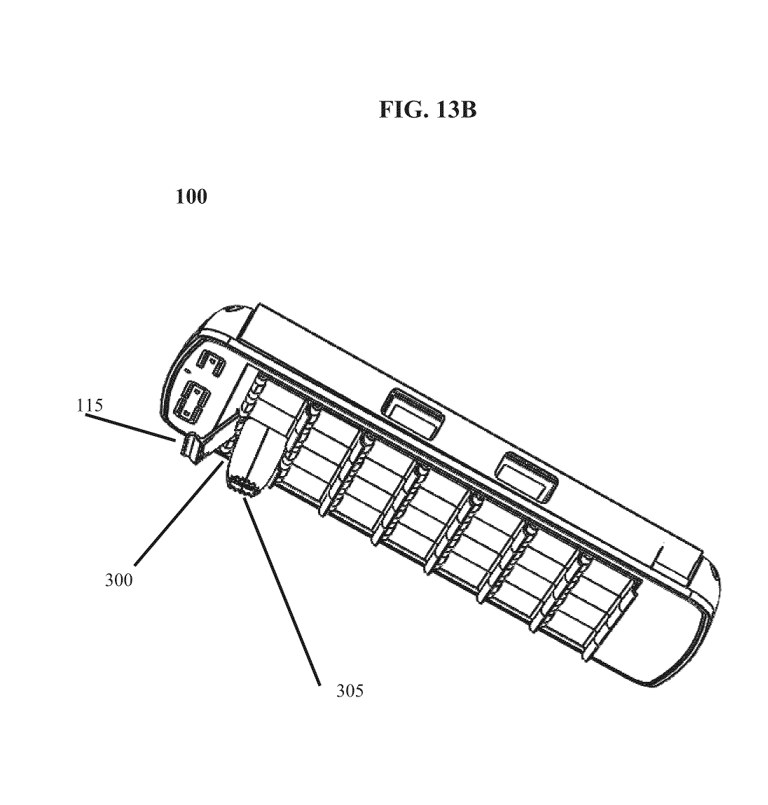

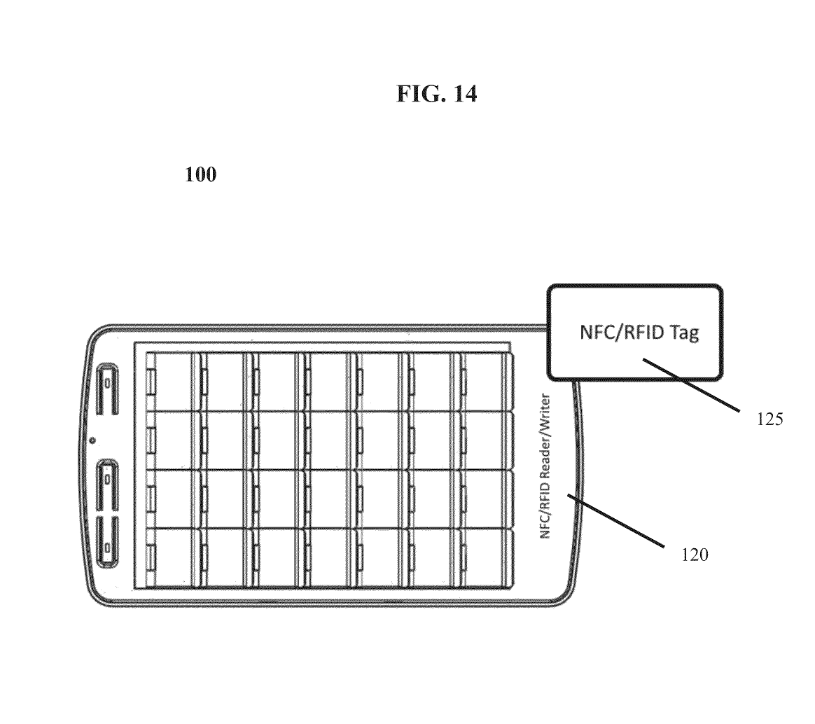

In order to take medication, a user (for example, a patient) needs to open the lid 115 (for example, FIGS. 1, 5, 6, 10, 11, 13A, 13B) and take the medication found in the medication holding compartment cavity 212 underneath. If the (blister pack or tray) medication holder 200 is sealed with a foil (for example, 245 in FIGS. 4, 11, and 13A) then the user needs first to break/tear the medication holder (blister pack or tray) foil 240 underneath the lid 115 and then take the medication found in the medication compartment cavity 212 covered by the broken/torn foil 245. The medication dispensing device 100, optionally, may be provided with an optional medication cup (for example, 300 in FIGS. 12, 13A, 13B) that can be used both to tear the medication holder (blister pack or tray) foil 245 by using special tearing elements, such as tearing teeth (for example, 305) of the medication cup 300 and to retrieve and hold the medication removed from the blister pack or tray medication holding compartment cavity 212. By turning the medication dispensing device 100 upside down after the medication cup teeth 305 tear the foil 245, the medication stored in the medication holding compartment cavity 212 is dropped directly into the medication cup 300 and can be retrieved from there by the user (as shown in FIGS. 13A-13B).

For the medication cup 300, optionally, the size (for example, width, diameter) of the first end with the tearing elements 305, optionally, is configured to be smaller than the size (for example, width, diameter) of the medication holding compartment 212 and of the medication holder (blister pack or tray) foil 240 underneath the lid 115. Optionally, the shape of the medication cup 300 corresponds to, or even matches, the shape of the medication holding compartment 212. Optionally, the medication cup 300 has a conical shape for correctly fitting into the medication holding compartment 212.

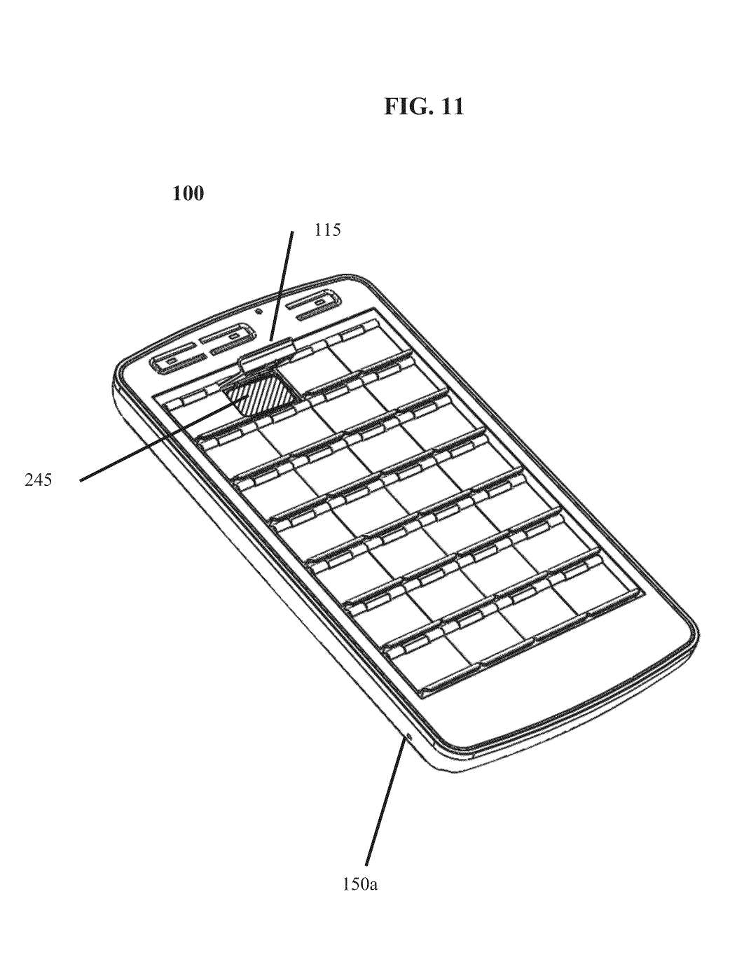

The medication dispensing device 100, optionally, identifies which medication holding compartment cavity 212 is opened and when by detecting (for example, in FIG. 10, via medication holding compartment sensor 130) the opening and closing of the lid/s 115 and/or the tear of a specific medication holding compartment cavity foil 245.

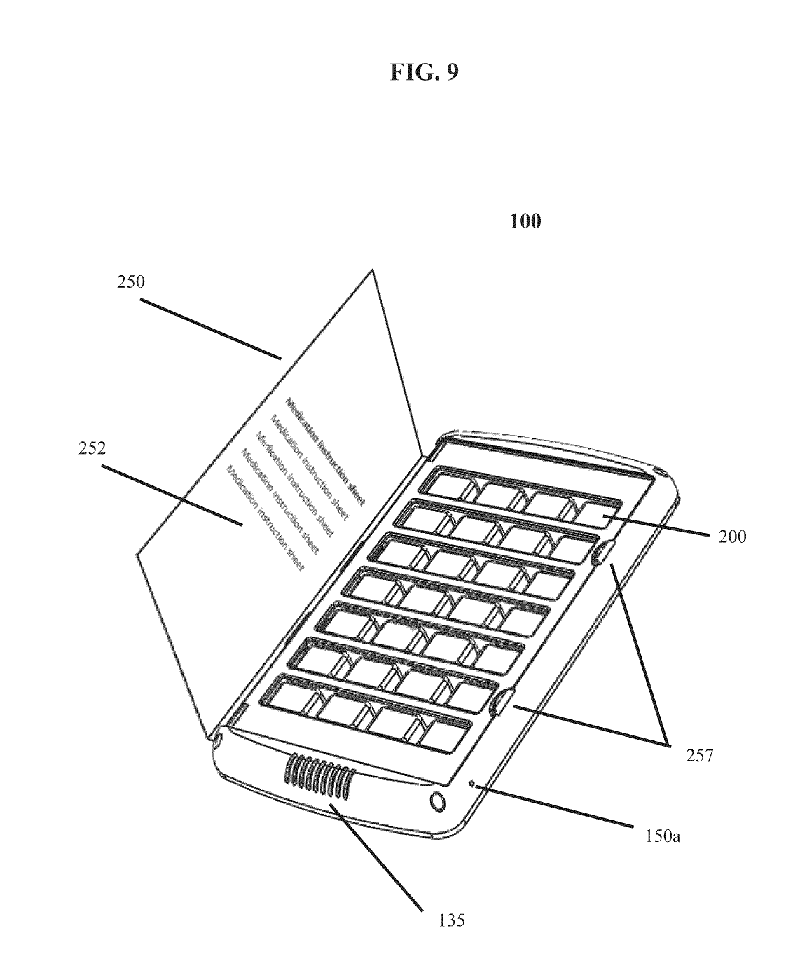

The medication dispensing device 100, optionally, reminds (by audio and visual methods), for example, via a speaker 135 [FIG. 8] and a display 140 [FIG. 1], when to take medications and from which medication holder (blister pack/tray) medication holding compartment cavity 212 it should be taken.

The medication dispensing device 100, optionally, can track the use and status of the medication dispensing device 100 and report to a server any change of status, such as “medication was dispensed”, “open lid”, “refill is required”, “refill was performed”, “medication dispensing time is over”, “medication was dispense out of time”, “wrong lid was opened”, “early dose was take”, “low battery”, “out of power”, etc.

The medication dispensing device 100 and its medication dispensing schedule, optionally, can be programmed from a remote server.

The medication dispensing device lids 115, optionally, block direct sunlight from reaching the medication and tampering with it.

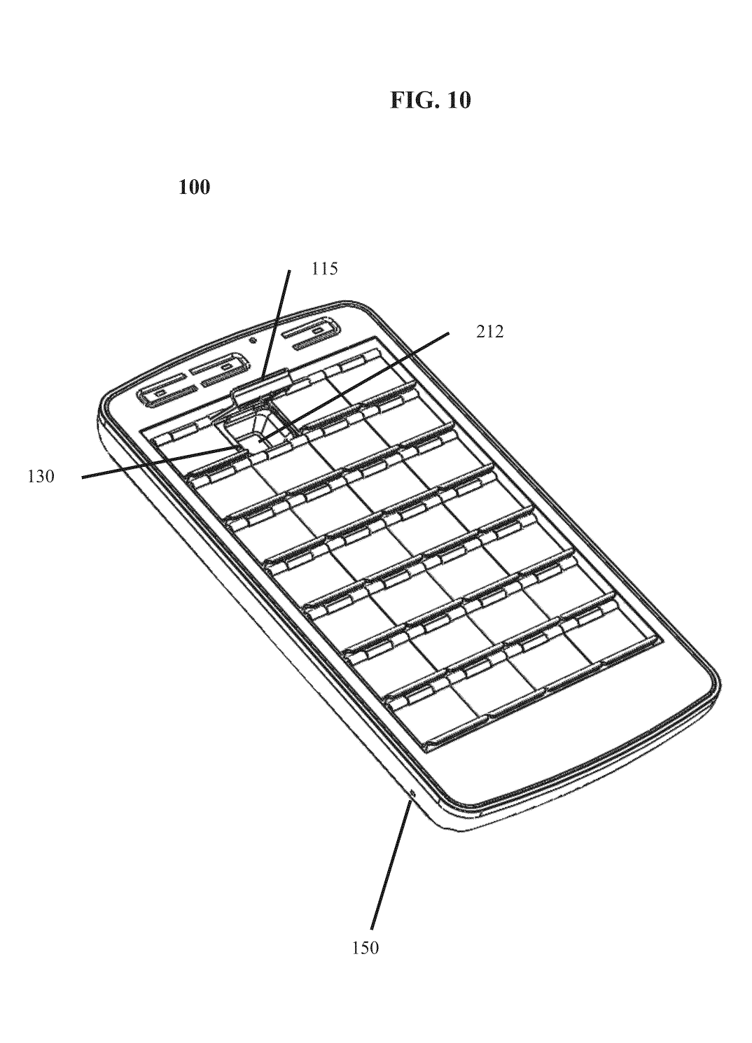

The medication dispensing device mechanics, optionally, allows a clear access to and the viewing of a medication instruction sheet (for example, 250 in FIGS. 2 and 9), without any need to remove the (blister pack or tray) medication holder 200. This allows the user to read the medication instructions (for example, 252 in FIGS. 2 and 9) attached to the (blister pack/tray) medication holder 200 without having to pull out or manipulate the (blister pack/tray) medication holder 200.

The bottom/back side (for example, 255 in FIGS. 8) of either the blister pack or tray medication holder 200, optionally, can be transparent. The medication dispensing device 100, optionally, allows a user to view the medications stored in the (blister pack or tray) medication holder 200 from the bottom/back side of the medication dispensing device 100, without opening the lids 115 or removing the (blister pack or tray) medication holder 200, to enable the user to see the status of the medication supply—how much medication is still left in the (blister pack or tray) medication holder 200, which medication is stored in each (blister pack or tray) medication holding compartment cavity 212, which medication holding compartment cavities 212 are empty and which medication holding compartment cavities 212 still store medications.

The medication dispensing device 100, optionally, may include holding elements (such as clips, clamps, notches), (for example, 257 in FIGS. 8 and 9) for holding the bottom/back side 255 of the blister pack medication holder 205, or for holding the medication instructions sheet 250, in a closed position.

The medication dispensing device 100, optionally, includes an optional built-in NFC reader and/or transmitter (for example, 120 in FIG. 14), to allow timesheet management of caregiver visiting the user/medication dispensing device 100. The caregiver, optionally, taps the NFC/RFID tag 125 on the medication dispensing device 100 and the medication dispensing device 100 uses its communication channel (for example, via a wired network; or via a wireless network, such as GSM [global system for mobile communications] or Wi-Fi) to a server to report the identity of the caregiver and the time he/she clocks in or clocks out. Alternatively, the caregiver can tap his/her NFC-reader equipped communication device to the medication dispensing device 100, read the NFC/RFID code or data-information of the medication dispensing device 100 and then use the caregiver communication device to transmit this code or data-information to the server, for clocking in and out of service to the user.

The medication dispensing device 100, optionally, includes an optional built-in short-range transceiver, such as Bluetooth or BLE (Bluetooth Low Energy), to communicate with and receive data-information from other sensors or/and telehealth monitoring devices. The medication dispensing device 100, optionally, sends and uploads this data-information to the server using the medication dispensing device own communication channel to a server or records the data-information on the NFC/RFID tag 125 as described hereinabove. The medication dispensing device 100, optionally, can also get instructions and data from the server and deliver to the sensors and telehealth monitoring devices.

When the medication dispensing device 100 is used to communicate with other telehealth monitoring or measurement devices, as described herein above, the NFC/RFID reader 120, optionally, can be used to uniquely identify the user for which the collected telehealth data is related to/associated with. This resolves the common problem of receiving/collecting data-information from telehealth monitoring/measurement devices that do not have a user identification mechanism to distinguish between the different users of the same telehealth/measurement device, causing the erroneous treatment of the data or/and information collected from a number of different users as if it relates to one single individual.

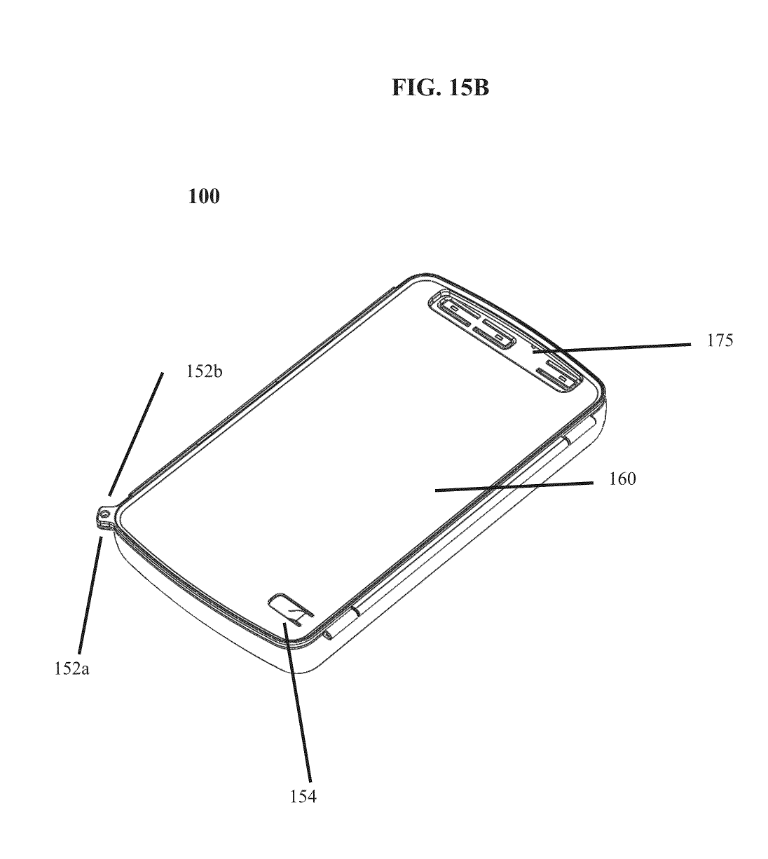

The medication dispensing device 100, optionally, has an optional add-on locking mechanism (for example, locking elements 150a, 150b, 152a, 152b, 154 in FIGS. 8, 9, 10, 11, 15A, and 15B) that automatically locks access to the medication dispensing device lids 115 and that prevents the removal of the (blister pack or tray) medication holder 200 when it is not medication or refill time (FIGS. 12-A and 12-B). The locking mechanism, optionally, interfaces with a medication dispensing device cover (for example, 160 in FIGS. 15A, 15B) and has locking elements.

The medication dispensing device 100, optionally, can have various means of power supply, and can be operated by DC power which optionally is located on the upper or the lower part the medication dispensing device 100, and/or by internal rechargeable battery/ies. The medication dispensing device 100, optionally, includes a connector (for example, 165 in FIG. 7B) for connecting to a DC power supply.

The medication dispensing device 100, optionally, can have a microphone (for example, 170 in FIG. 1) for audio recording of specific instructions, or/and for enabling a user (patient) to talk with a caregiver located, for example, at a call center or health facility.

The medication dispensing device cover 160, optionally, may be configured so that in a closed position user accessibility to the display 140 and microphone 170 (FIG. 1) is maintained, for example, as shown by 175 in FIG. 15B.

Some embodiments disclosed herein may be implemented by including some features disclosed in same applicant/assignee U.S. Pat. No. 8,085,135.

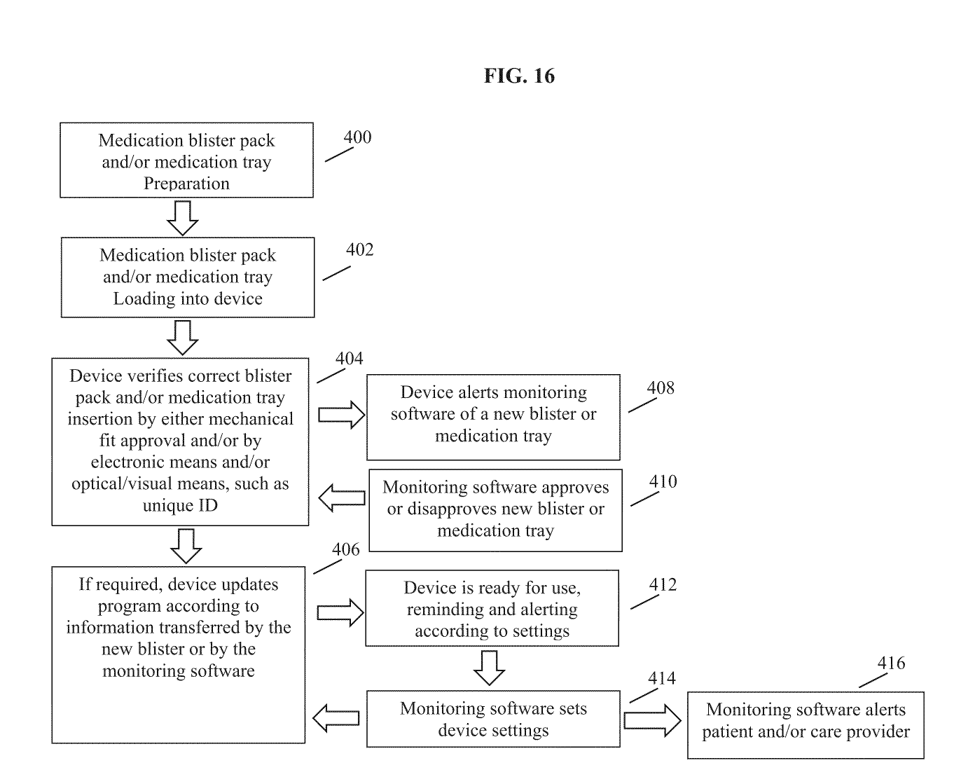

FIG. 16 is a flow diagram of a method for dispensing medication. According to an aspect of some embodiments of the invention, the method for dispensing medication includes: providing a medication dispensing device; providing a medication holder having at least one medication holding compartment filled with medication; inserting, by sliding, the medication holder into the medication dispensing device; sensing an indication of the inserted medication holder; verifying the inserted medication holder as being correct; and retrieving medication from at least one of the filled medication holding compartments.

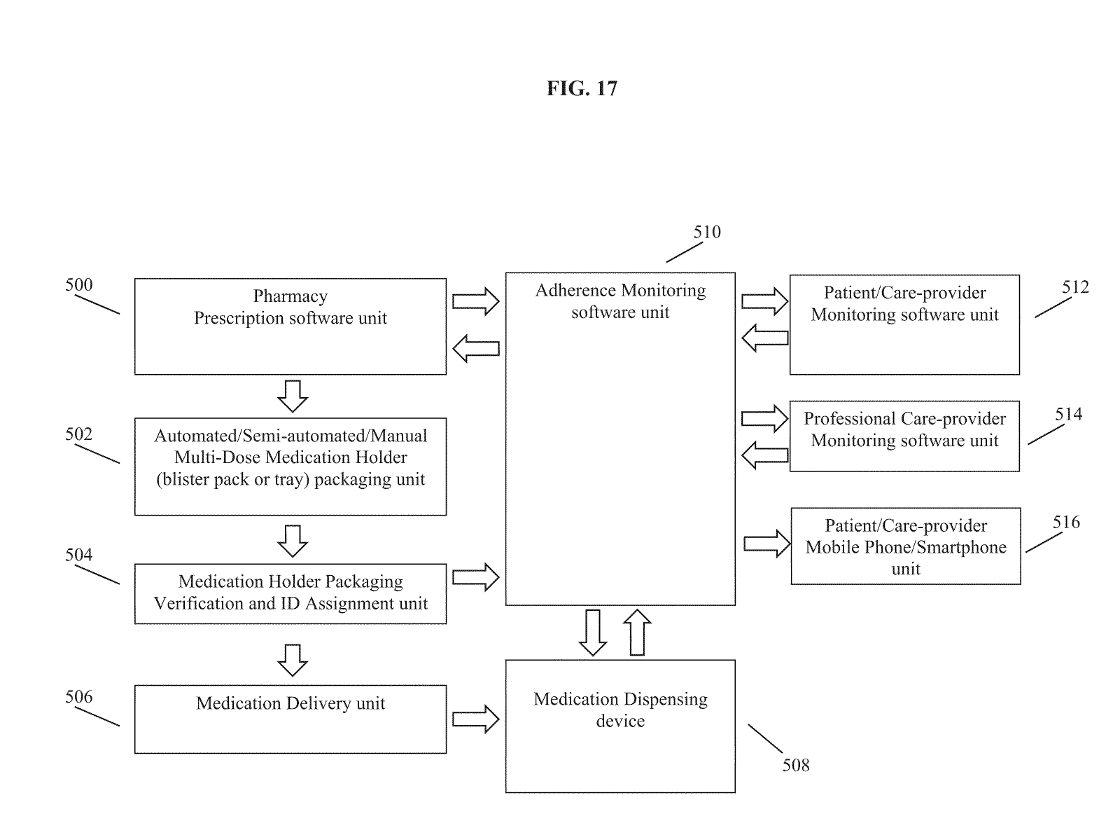

FIG. 17 is a flow diagram of a system for dispensing medication. According to an aspect of some embodiments of the invention, the medication dispensing system includes: a medication dispensing device comprising a housing having a sliding mechanism; and a medication holder comprising a receptacle containing a plurality of individual medication holding compartments, and configured to removably slide into and out of the medication dispensing device via the sliding mechanism.

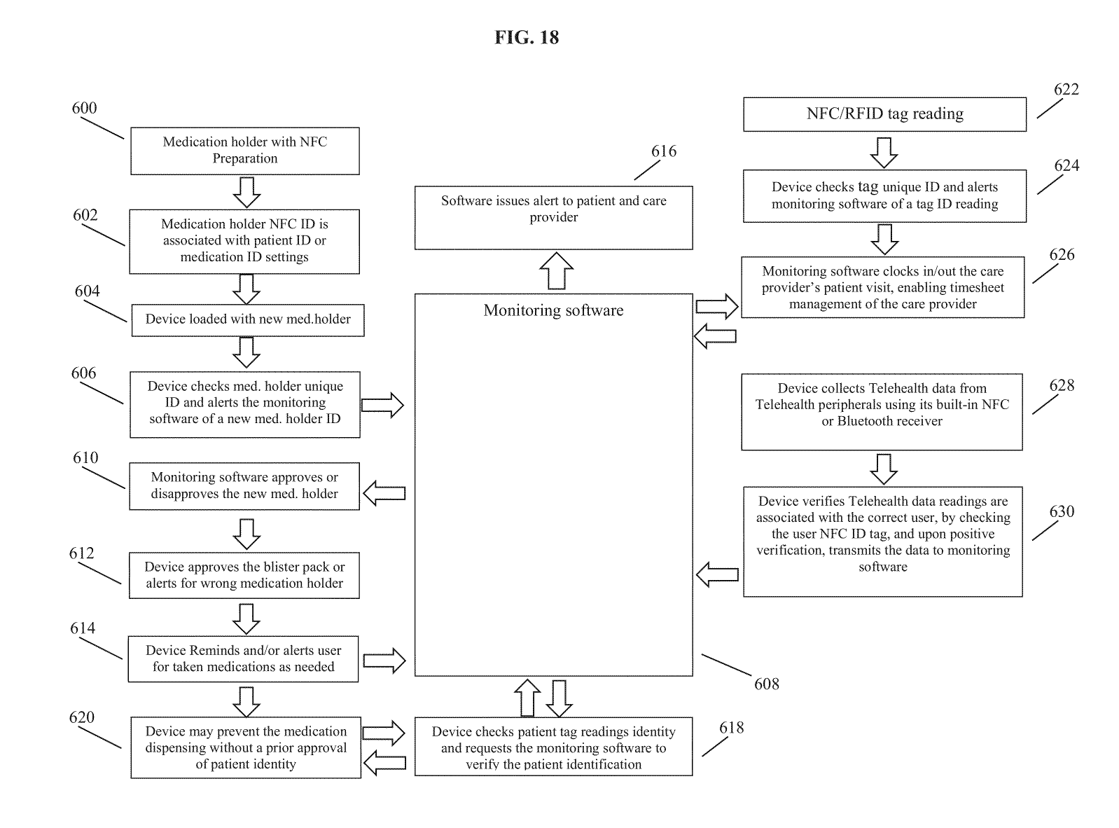

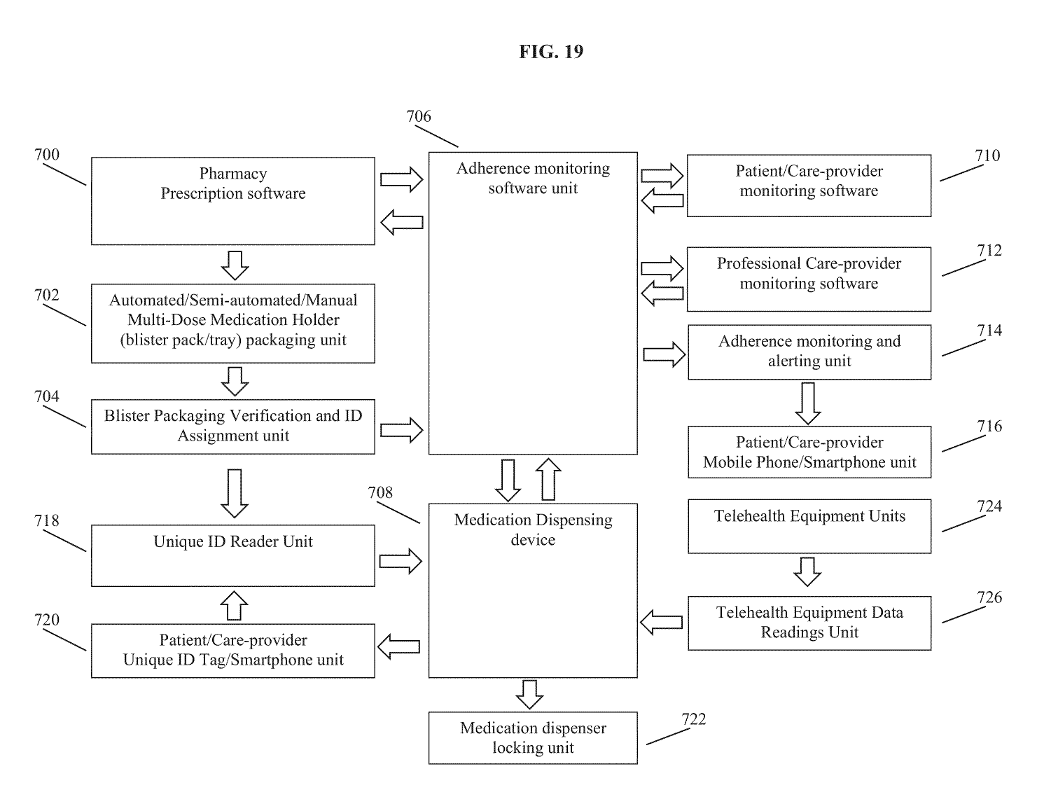

FIG. 18 is a flow diagram of a method for using computer readable (e.g., NFC [near field communication]) standards for monitoring and verifying patient and caregiver activities and health related data-information. FIG. 19 is a flow diagram of a system for using computer readable (e.g., NFC) standards for monitoring and verifying patient and caregiver activities and health related data-information.

According to an aspect of some embodiments of the invention, the method for using computer readable (e.g., NFC [near field communication]) standards for monitoring visit of a caregiver to a patient includes: providing to the patient a medication dispensing device configured with RFID circuitry operative according to the computer readable (NFC) standards; providing to the caregiver an RFID tag operative according to the computer readable standards and containing caregiver ID data-information; communicating the caregiver ID data-information to the medication dispensing device RFID circuitry via the computer readable (NFC) standards; and analyzing the caregiver ID data-information by the RFID circuitry.

According to some embodiments of the invention, the communicating includes communicating arrival and departure time data-information of the caregiver to the patient.

According to some embodiments of the invention, the analyzing includes verifying correctness of the caregiver ID data-information.

According to an aspect of some embodiments of the invention, the method for using computer readable (e.g., NFC) standards for verifying health data-information of a patient includes: providing to the patient a medication dispensing device configured with RFID circuitry operative according to the computer readable (NFC) standards and containing patient health data-information; providing to the patient an RFID tag operative according to the computer readable (NFC) standards and containing patient ID data-information; communicating the patient ID data-information to the medication dispensing device RFID circuitry via the computer readable (NFC) standards; and verifying association of the patient health data-information with the patient ID data-information by the RFID circuitry.

Each of the following terms written in singular grammatical form: ‘a’, ‘an’, and ‘the’, as used herein, means ‘at least one’, or ‘one or more’. Use of the phrase ‘one or more’ herein does not alter this intended meaning of ‘a’, ‘an’, or ‘the’. Accordingly, the terms ‘a’, ‘an’, and ‘the’, as used herein, may also refer to, and encompass, a plurality of the stated entity or object, unless otherwise specifically defined or stated herein, or, unless the context clearly dictates otherwise. For example, the phrases: ‘a unit’, ‘a device’, ‘an assembly’, ‘a mechanism’, ‘a component’, ‘an element’, and ‘a step or procedure’, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: ‘includes’, ‘including’, ‘has’, ‘having’, ‘comprises’, and ‘comprising’, and, their linguistic/grammatical variants, derivatives, or/and conjugates, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase ‘consisting essentially of’.

Each of the phrases ‘consisting of’ and ‘consists of’ as used herein, means ‘including and limited to’.

The phrase ‘consisting essentially of’ as used herein, means that the stated entity or item (system, system unit, system sub-unit, device, assembly, sub-assembly, mechanism, structure, component, element, or, peripheral equipment, utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional ‘feature or characteristic’ being a system unit, system sub-unit, device, assembly, sub-assembly, mechanism, structure, component, or element, or, peripheral equipment, utility, accessory, or material, step or procedure, sub-step or sub-procedure), but only if each such additional ‘feature or characteristic’ does not materially alter the basic novel and inventive characteristics or special technical features, of the claimed entity or item.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably. For example, for stating or describing the numerical range of room temperature, the phrase ‘room temperature refers to a temperature in a range of between about 20° C. and about 25° C’, and is considered equivalent to, and meaning the same as, the phrase ‘room temperature refers to a temperature in a range of from about 20° C. to about 25° C’.

The phrase ‘operatively connected’, as used herein, equivalently refers to the corresponding synonymous phrases ‘operatively joined’, and ‘operatively attached’, where the operative connection, operative joint, or operative attachment, is according to a physical, or/and electrical, or/and electronic, or/and mechanical, or/and electro-mechanical, manner or nature, involving various types and kinds of hardware or/and software equipment and components.

It is to be fully understood that certain aspects, characteristics, and features, of the present invention, which are illustratively described and presented in the context or format of a plurality of separate embodiments, may also be illustratively described and presented in any suitable combination or sub-combination in the context or format of a single embodiment. Conversely, various aspects, characteristics, and features, of the present invention, which are illustratively described and presented in combination or sub-combination in the context or format of a single embodiment, may also be illustratively described and presented in the context or format of a plurality of separate embodiments.

Although the present invention has been illustratively described and presented by way of specific exemplary embodiments thereof, and examples thereof, it is evident that many alternatives, modifications, and variations, thereof, will be apparent to those skilled in the art. Accordingly, it is intended that all such alternatives, modifications, and variations, fall within, and are encompassed by, the scope of the appended claims.

All patents, patent applications, and publications, cited or referred to in this specification are herein incorporated in their entirety by reference into the specification, to the same extent as if each individual patent, patent application, or publication, was specifically and individually indicated to be incorporated herein by reference. In addition, citation or identification of any reference in this specification shall not be construed or understood as an admission that such reference represents or corresponds to prior art of the present invention. To the extent that section headings are used, they should not be construed as necessarily limiting.

1. The system of claim 22 wherein said sliding mechanism is configured to receive, hold, and release a removably slidable medication holder containing a plurality of individual medication holding compartments.

2-5. (canceled)

6. The system of claim 22, wherein said medication dispensing device comprising one or more electronic sensors configured to sense insertion or/and removal, via said sliding mechanism, of said medication holder.

7-10. (canceled)

11. The system of claim 22, wherein said A medication holder is having one side configured with one or more outward facing holes or an outward facing external handle to facilitate removably sliding the medication holder into and out of a medication dispensing device.

12-13. (canceled)

14. The system of claim 22, wherein said receptacle is configured with an RFID or NFC tag.

15. (canceled)

16. The system of claim 14, wherein said RFID or NFC tag is configured to send programming data-information to said medication dispensing device, wherein said data-information is used to program said medication dispensing device.

17-21. (canceled)

22. A medication dispensing system, comprising:
a medication dispensing device comprising a housing having a sliding mechanism; and
a medication holder comprising a receptacle containing a plurality of individual medication holding compartments, and configured to removably slide into and out of said medication dispensing device via said sliding mechanism.

23. The system of claim 22, wherein said sliding mechanism is configured to receive, hold, and release said medication holder according to at least one feature selected from the group consisting of structural features, electronic features, RF features, magnetic features, and visual features.

24. The system of claim 22, wherein said sliding mechanism is configured to receive, hold, and release said medication holder having one or more specific structural features.

25. The system of claim 24, comprising structural features correspondingly matching said one or more specific structural features of said medication holder.

26. The system of claim 25, wherein said correspondingly matching structural features are spatial clearances, pegs, or a combination thereof.

27. The system of claim 22, comprising at least one electronic reader selected from the group consisting of NFC readers, RFID readers, QR code readers, and barcode readers.

28. The system of claim 27, wherein a said electronic reader is configured to communicate with said medication holder.

29. The system of claim 22, comprising at least one electronic writer configured to record on an NFC/RFID tag in response to receiving data from said medication holder.

30. The system of claim 29, wherein said at least one electronic writer is selected from the group consisting of NFC writers and RFID writers.

31-35. (canceled)

36. A method for using computer readable standards for verifying health data-information of a patient, the method comprising:
providing to the patient a medication dispensing device configured with RFID circuitry operative according to the computer readable standards and containing patient health data-information;
providing to the patient an RFID tag operative according to the computer readable standards and containing patient ID data-information;
communicating said patient ID data-information to said medication dispensing device RFID circuitry via the computer readable standards; and
verifying association of said patient health data-information with said patient ID data-information by said RFID circuitry.

37. The method of claim 36, wherein the computer readable standards are NFC (near field communication) standards.

38. The method of claim 36, wherein the computer readable standards are QR code standards.

39. A method for using computer readable standards for dispensing medication, the method comprising:
providing a medication dispensing device configured with RFID circuitry operative according to the computer readable standards;
providing a medication holder configured with an RFID tag operative according to the computer readable standards and containing medication holder ID data-information, said medication holder has at least one medication holding compartment filled with medication;
inserting said medication holder into said medication dispensing device;
communicating said medication holder ID data-information to said medication dispensing device RFID circuitry via the computer readable standards; and
verifying said inserted medication holder as being correct by said RFID circuitry.

40. The method of claim 39, wherein the computer readable standards are NFC (near field communication) standards.

41. The method of claim 39, wherein the computer readable standards are QR code standards.
